(19) United States
(12) Patent Application Publication
(10) Pub. No.: US 2011/0018835 A1
(43) Pub. Date: Jan. 27, 2011

(54) INPUT DETECTION DEVICE, INPUT DETECTION METHOD, PROGRAM, AND STORAGE MEDIUM

(76) Inventors: Atsuhito Murai, Osaka (JP); Masaki Uehata, Osaka (JP)

Correspondence Address: BIRCH STEWART KOLASCH & BIRCH, PO BOX 747, FALLS CHURCH, VA, 22040-0747, US

(21) Appl. No.: 12/934,051

(22) PCT Filed: Jan. 19, 2009
(86) PCT No.: PCT/JP2009/050692

§ 371 Date: Sep. 22, 2010

(30) Foreign Application Priority Data
Jun. 3, 2008 (JP) 2008-145658

(51) Int. Cl. G06F 3/041

(52) U.S. Cl. 345/173

(57) ABSTRACT

An input detection device (1) of the present invention has a multi-point detection touch panel (3), and further includes: image generation means generating an image of an object sensed by the touch panel (3); determination means determining whether or not the image matches a predetermined reference image prepared in advance; and coordinate finding means finding, if the image is determined not to match the reference image by the determination means, coordinates of the image on the touch panel (3). This allows the input detection device (1) having the multi-point detection touch panel (3) to sense only a necessary input and to avoid an improper operation.

### TECHNICAL FIELD

The present invention relates to an input detection device having a multi-point detection touch panel, an input detection method, a program, and a storage medium.

### BACKGROUND ART

In a conventional input detection device having a multi-point detection touch panel, plural pieces of position information inputted on a screen are simultaneously processed to perform an operation specified by a user. Examples of an object with which the touch panel is touched to input the position information include a finger, a pen, and the like, in particular. Some of the conventional input detection devices are configured to detect the input with use of these objects on a whole screen display section, while others are configured to detect the input on a predetermined display region which is part of a screen.

The technique of detecting the input on the whole screen display section is disclosed in Patent Literature 1. The technique disclosed in Patent Literature 1 enables an advanced manipulation based on simultaneous touches on a plurality of spots on the screen display section.

In the technique of Patent Literature 1, however, even an input that is not intended by a user may be sensed. For example, there are cases where a finger of the user's hand holding the device is sensed. This can lead to an improper operation that is not intended by the user. As yet, there is no known input detection device that can distinguish an input with the finger of the user's hand holding the device from inputs with the other objects and process the inputs with the other objects as proper inputs.

The technique of detecting an input on the predetermined display region is disclosed in Patent Literature 2. The technique of Patent Literature 2 is to read fingerprint data inputted to a plurality of predetermined display regions.

However, as mentioned above, the area of the display region in which the input is read is predetermined. In addition, the object performing the input is limited to fingers. As such, advanced and free operability cannot be expected. There is no known input detection device that can be configured to detect a touch with a finger or an arbitrary object specified by the user as an input. Moreover, there is no known technique that can dynamically change, during screen display, the display region detecting an input depending on the position that the specified object touches.

### Citation List

Patent Literature 1

Japanese Patent Application Publication Tokukai No. 2007-58552 A (Mar. 8, 2007)

Patent Literature 2

Japanese Patent Application Publication Tokukai No. 2005-175555 A (Jun. 30, 2005)

### SUMMARY OF INVENTION

As described above, a conventional input detection device having a multi-point detection touch panel may sense even an input not intended by the user. This can result in an improper operation.

The present invention is achieved in view of the above problem, and an object of the present invention is to provide an input detection device having a multi-point detection touch panel, an input detection method, a program, and a storage medium, each of which makes it possible to correctly obtain input coordinates intended by the user. This will be accomplished by detecting coordinates of an input only if the input is sensed as a necessary input.

(Input Detection Device)

In order to achieve the above object, an input detection device according to the present invention having a multi-point detection touch panel includes: image generation means generating an image of an object sensed by the touch panel; determination means determining whether or not the image matches a predetermined reference image prepared in advance; and coordinate finding means finding, if the image is determined not to match the reference image by the determination means, coordinates of the image on the touch panel.

According to the above configuration, the input detection device includes the multi-point detection touch panel. The “multi-point detection touch panel” is such a touch panel that can detect, in a case where a plurality of fingers touch the touch panel at a time, touch positions (points) of the respective fingers simultaneously.

The present input detection device further includes the image generation means generating the image of the object sensed by the touch panel. This makes it possible to generate images of the respective input points sensed by the touch panel.

The present input detection device further includes the determination means determining whether or not the generated image matches the predetermined reference image prepared in advance. The “reference image” is an image that is sensed as an image whose coordinates are not to be detected. Therefore, in a case where the generated image matches the reference image, the present input detection device senses the generated image as the image whose coordinates are not to be detected.

On the other hand, in a case where the generated image does not match the reference image, the present input detection device senses the generated image as an image whose coordinates are to be detected. On this account, the present input detection device further includes the coordinate finding means finding the coordinates of the image on the touch panel. This allows detection of the coordinates of the image.

As described above, the present input detection device detects the coordinates of the image only if the input detection device senses the image whose coordinate needs to be detected. That is, the input detection device can correctly obtain the input coordinate intended by the user. This produces an effect of avoiding an improper manipulation of the touch panel.

(Registering Means)

It is preferable that the input detection device according to the present invention further includes registering means registering the image as a new reference.

According to the above configuration, the present input detection device further includes the registering means registering the image of the object sensed by the touch panel as the new reference image. This allows a plurality of reference images to be prepared in advance in the input detection device. Based on the plurality of reference images prepared in advance, precision of a function can be raised that determines whether or not the input by the user is an invalid input.

(Predetermined Region)

It is preferable that, in the input detection device according to the present invention, the determination means determines whether or not the image of the object sensed by the touch panel in a predetermined region in the touch panel matches the reference image.

According to the above configuration, the present input detection device determines whether or not the image of the object sensed by the touch panel in the predetermined region in the touch panel matches the reference image. This makes it possible to determine, as long as the object is sensed by the touch panel in the predetermined region, whether or not the image of the object matches the reference image. For an object sensed outside the predetermined region, the image of the object can be used to determine whether or not the sensing of the object is a proper input.

(Region Definition Means)

It is preferable that the input detection device according to the present invention further includes: registering means registering the image as a new reference image; and region definition means defining the predetermined region based on the registered new reference image.

According to the above configuration, the present input detection device further includes: the registering means registering the image as the new reference image; and the region definition means defining the predetermined region based on the registered new reference image. This allows the present input detection device to obtain the predetermined region defined based on the reference image. That is, it is possible to register in advance the display region in which the object to be sensed as the reference image is likely to touch the touch panel.

(Definition of Predetermined Region)

It is preferable that, in the input detection device according to the present invention, the region definition means defines, as the predetermined region, a region surrounded by one of a plurality of edges of the touch panel nearest to the new reference image and a line parallel to the edge and tangent to the new reference image.

According to the above configuration, the present input detection device defines, as the predetermined region, the region surrounded by one of the edges of the touch panel nearest to the new reference image and the line parallel to the edge and tangent to the reference image. This allows the input detection device to find more correctly and register in advance the display region in which the object to be sensed as the reference image is likely to touch the touch panel.

(Definition Based on End Part of Touch Panel)

It is preferable that, in the input detection device according to the present invention, the predetermined region is in a vicinity of an end part of the touch panel.

According to the above configuration, the present input detection device registers the vicinal region of the end part of the touch panel as the predetermined region. The end part of the touch panel is a region frequently touched by the user's hand holding the touch panel and by the other fingers. The registration of this region as the predetermined region makes it easier for the input detection device to detect the reference images of the hand holding the touch panel and the fingers.

(Image of a Finger)

It is preferable that, in the input detection device according to the present invention, the reference image is an image of a finger of a user.

According to the above configuration, the present input detection device registers the reference image obtained from the user's finger. In a case where the reference image is an image of a human finger, this makes it less likely to erroneously sense the input by the other object as the reference image.

(Method of Detecting Input)

In order to achieve the above objective, a method of detecting an input according to the present invention, which method is executed by an input detection device having a multi-point detection touch panel, includes the steps of: generating an image of an object sensed by the touch panel; determining whether or not the image matches a predetermined reference image prepared in advance; and finding, if the image is determined not to match the reference image by the determination means, coordinates of the image on the touch panel.

The above configuration produces advantages and effects that are similar to those of the above described input detection device.

(Program and Storage Medium)

The input detection device according to the present invention may be realized by a computer. In that case, a program causing a computer to function as each of the foregoing means to realize the input detection device in the computer and a computer readable storage medium in which the program is stored fall within the scope of the present invention.

The other objectives, features, and advantages of the present invention will be fully understood from the following description. The benefits of the present invention will become apparent from the following explanation with reference to the accompanying drawings.

### BRIEF DESCRIPTION OF DRAWINGS

FIG. 1

FIG. 1 is a block diagram illustrating a configuration of an essential part of an input detection device according to an embodiment of the present invention.

FIG. 2

FIG. 2 is a drawing illustrating a configuration of an essential part of a display unit.

FIG. 3

FIG. 3 is a drawing illustrating an example of use of a touch panel.

FIG. 4

FIG. 4 is a drawing illustrating images of a finger inputted on screens with different display luminance.

FIG. 5

FIG. 5 is a flow chart showing a processing flow for registering a reference image in the input detection device according to the embodiment of the present invention.

FIG. 6

FIG. 6 is a flow chart showing a processing flow for detecting a touch by a user on the touch panel in the input detection device according to the embodiment of the present invention.

FIG. 7

FIG. 7 is a flow chart showing a processing flow for extracting the input by the user on the touch panel as a target image.

FIG. 8

FIG. 8 is a flow chart showing a processing flow for registering the target image as a reference image.

FIG. 9

FIG. 9 is a drawing illustrating an example of use of the touch panel which example is different from the example illustrated in FIG. 3.

FIG. 10

FIG. 10 is a drawing illustrating a region in which the matching between the input image and the reference image is performed and a region in which the matching is not performed.

FIG. 11

FIG. 11 is a flow chart showing a processing flow for registering the region in which the matching between the input image and the reference image is performed.

FIG. 12

FIG. 12 is a drawing illustrating steps of detecting and registering coordinates of end points of the reference images.

FIG. 13

FIG. 13 is a drawing illustrating a region defined based on the coordinates of the respective reference images in which region the matching of the input images and the reference images is performed.

FIG. 14

FIG. 14 is a flow chart showing a flow of processes in the input detection device according to the embodiment of the present invention when the touch panel is in use.

FIG. 15

FIG. 15 is a drawing presented to explain an additional effect of the input detection device according to the embodiment of the present invention.

### REFERENCE SIGNS LIST

1 Input Detection Device (Input Detection Device)
2 Display Unit
3 Touch Panel (Touch Panel)
4 Display Process Section
5 Input Section
6 Input Image Sensing Section
7 Reference Image Registration Section (Registering Means)
8 Memory
9 Matching Target Region Definition Section (Region Definition Means)
10 Valid Image Selection Section
11 Input Coordinate Detection Section (Coordinate Finding Means)
12 Application Control Section
20 Display Driver
21 Readout Driver
30 Pen
31 Finger
32 Input Region
33 Hand
34 Input Region
40 Finger
41, 43, 45 Screens
42, 44, 46 Images
90 Hand
101, 102, 103, 104 Reference Images
105 Target Region
106 Nontarget Region
120, 121 Coordinates
122, 124, 126, 128 Lines
123, 125, 127, 129 Dashed Lines
131, 132, 133, 134 Coordinates
154 Finger
155 Hand
156 Dashed Line

### DESCRIPTION OF EMBODIMENTS

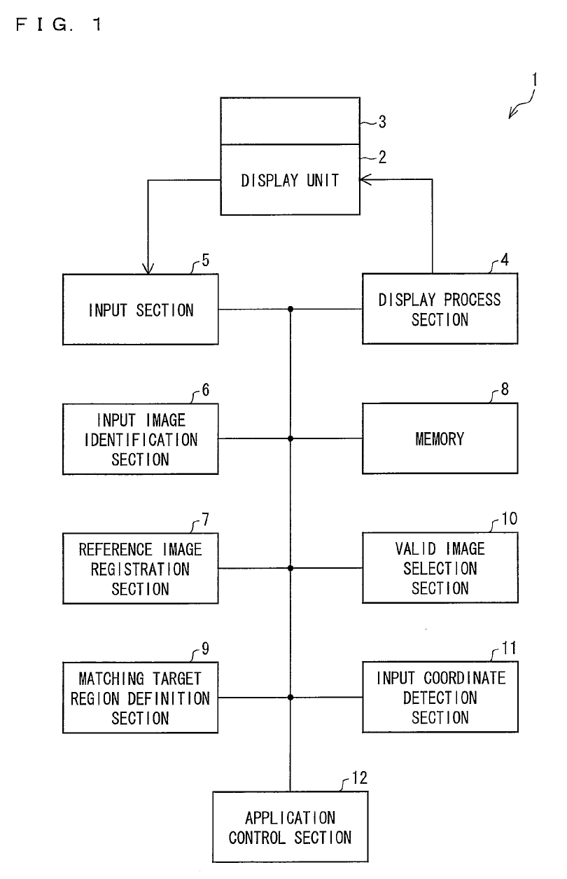

The following describes an embodiment of an input detection device according to the present invention with reference to FIGS. 1 to 15.

(Configuration of Input Detection Device 1)

First is described a configuration of an essential part of an input detection device 1 according to an embodiment of the present invention with reference to FIG. 1.

FIG. 1 is a block diagram illustrating the configuration of the essential part of the input detection device 1 according to an embodiment of the present invention. As illustrated in FIG. 1, the input detection device 1 includes a display unit 2, a touch panel 3, a display process section 4, an input section 5, an input image identification section 6, a reference image registration section 7, a memory 8, a matching target region definition section 9, a valid image selection section 10, an input coordinate detection section 11, and an application control section 12. The details of the respective members will be described later.

(Configuration of Display Unit 2)

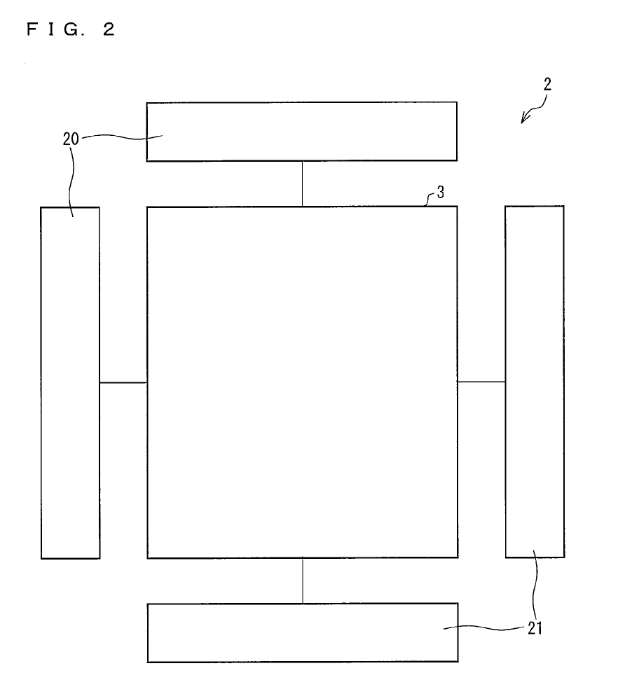

Referring to FIG. 2, described below is a configuration of the display unit 2 according to the present embodiment. As illustrated in FIG. 2, the display unit 2 includes a touch panel 3, display drivers 20, and readout drivers 21. The display drivers 20 and the readout drivers 21 are disposed so as to surround the touch panel 3 and face each other across the touch panel 3. The details of the respective members will be described later. The touch panel 3 according to the present embodiment is a multi-point detection touch panel. Here, an internal configuration of the touch panel 3 is not particularly limited. An optical sensor may be used for the configuration, or other configurations are also possible. Although not particularly specified here, the touch panel 3 may sense multipoint inputs by a user.

The term “sense” here means to determine whether or not there is a touch panel operation and to identify an image of the object on the operation screen by using “press, touch, shade, light, and so on”. Examples of such a touch panel that uses “press, touch, shade, light, and so on” to “sense” includes the following:

(1) A touch panel using a “physical touch” on the operation screen with a pen, finger, or the like; and (2) a touch panel provided with a so-called photodiode under the operation screen. The photodiode produces output current of different levels depending on amount of energy of the received light. The touch panel of the type (2) uses a difference of the amount of energy of the received light of the photo diode in the operation screen, which difference is produced when manipulating the touch panel with the pen, the finger, and the like in an environment of various ambient lights.

Typical examples of the touch panel of the type (1) include a resistive touch panel, a capacitive touch panel, an electromagnetic induction touch panel, and the like (detailed description is omitted). Meanwhile, representative examples of the touch panel of the type (2) include a touch panel using an optical sensor.

(Driving of Touch Panel 3)

The following describes driving of the touch panel 3 with reference to FIGS. 1 and 2.

In the input detection device 1, first, the display process section 4 supplies the display unit 2 with a display signal for displaying a UI screen. “UI” stands for “User Interface”. That is, the UI screen is a screen that the user touches directly or with an object to give an instruction for executing a necessary process. The display drivers 20 in the display unit 2 supply the received display signal to the touch panel 3. The touch panel 3 displays the UI screen in accordance with the supplied display signal.

(Readout of Sensing Data)

The following describes readout of sensing data in the touch panel 3 with reference to FIGS. 1 and 2. Here, the “sensing data” is data representing an input by the user detected by the touch panel 3.

When the touch panel 3 receives an input by the user, the touch panel 3 supplies the sensing data to the readout drivers 21. The readout drivers 21 supply the input section 5 with the sensing data. This causes the input detection device 1 to be ready to execute various necessary processes.

(Example of Use of Touch Panel 3)

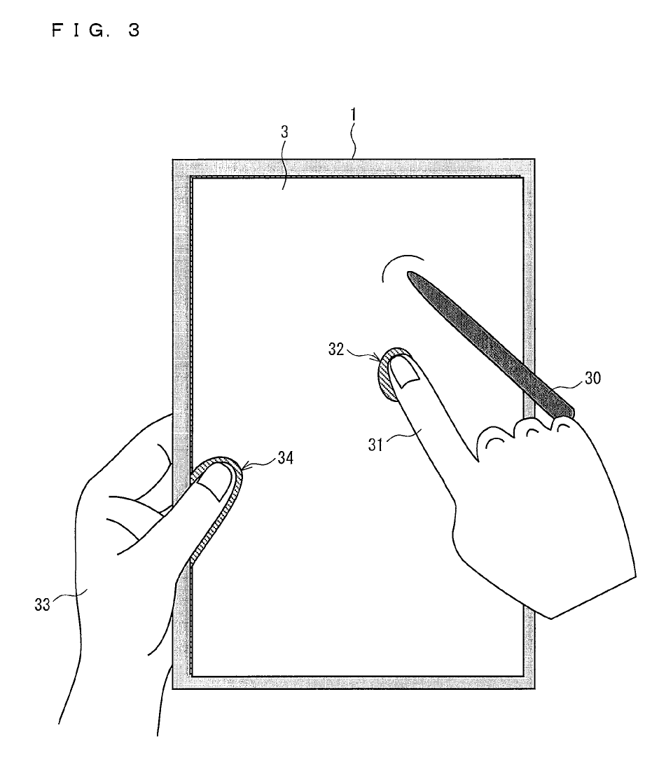

Now, an example of use of the touch panel 3 is described with reference to FIG. 3. FIG. 3 is a drawing illustrating an example of use of the touch panel 3.

As illustrated in FIG. 3, the user can perform an input to the touch panel 3 with use of a pen 30. The user can also perform the input by directly touching an arbitrary spot on the touch panel 3 with a finger 31. A shaded region 32 is an input region which is sensed as an input with the finger 31.

A hand 33 is a user's hand holding the input detection device 1 and touching the touch panel 3. Because the hand 33 touches the touch panel 3, the input detection device 1 also senses a region touched by the hand 33 as another input by the user. The region is shown as a shaded region 34.

This input is not originally intended by the user. As such, it can lead to an improper operation. In other words, the finger that touches the touch screen without an intension of an input can cause an improper operation.

(Example of Reference Image)

Hereinafter, the finger that touches the touch screen without an intention of an input is termed an “invalid finger”, and an image generated by sensing the invalid finger is termed a “reference image”.

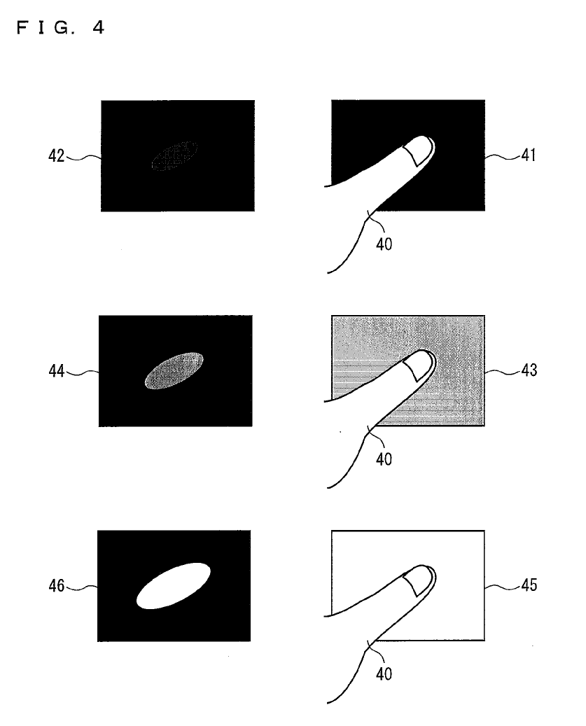

In order to sense an input that is not intended by the user as an invalid input, the input detection device 1 registers the reference image in advance. Referring to FIGS. 4 to 8, the following describes a processing flow for registering the reference image.

With reference to FIG. 4, first is described an example of the reference image to be registered. FIG. 4 illustrates images of a finger inputted on screens each with different display luminance. The display luminance of the screen displayed on the touch panel 3 changes depending on the ambient environment in which the user uses the input detection device 1. A change in the display luminance of the screen is accompanied by a change in quality of the image generated based on the input to the screen. That is, quality of the reference image changes as well. On this account, a reference image generated based on the input information of the screen with certain display luminance would not be sensed as a reference image on a screen with different display luminance. The following describes examples of the reference images generated on the screens each with different display luminance.

As illustrated in FIG. 4, the screens 41, 43, and 45 are different in display luminance. The screen 41 is the darkest screen, and the screen 45 is the brightest screen.

Assume that the user wishes the input by the finger 40 to be sensed as an invalid input, as described above. The user performs an input to each of the screens 41 to 43 with the finger 40. The images sensed here by the input detection device 1 are images 42, 44, and 46. The image 42 is an input image to the screen 41. In the same manner, the image 44 corresponds to the screen 43, and the image 46 corresponds to the screen 45.

As illustrated in FIG. 4, the image 46 generated based on the input to the bright screen 45 makes a sharper contrast than the image 42 generated based on the input to the dark screen 41.

If it is possible to register only one reference image, for example, the image 46 cannot be sensed as the reference image with the display luminance of the screen 41. This can lead to an improper operation. In order to reduce the possibilities of such improper operation, the input detection device according to the embodiment of the present invention can register a plurality of reference images. This allows the reference images to be sensed on the screens each with different display luminance. In this way, the reference images can be prevented from being not sensed. Of course it is also possible to register a plurality of reference images for a screen with the same display luminance.

The reference images may be registered at a time of turning on the input detection device 1, for example. This is because the user is likely to use the input detection device 1 at a time of turning on the input detection device 1.

(Registration of Reference Image)

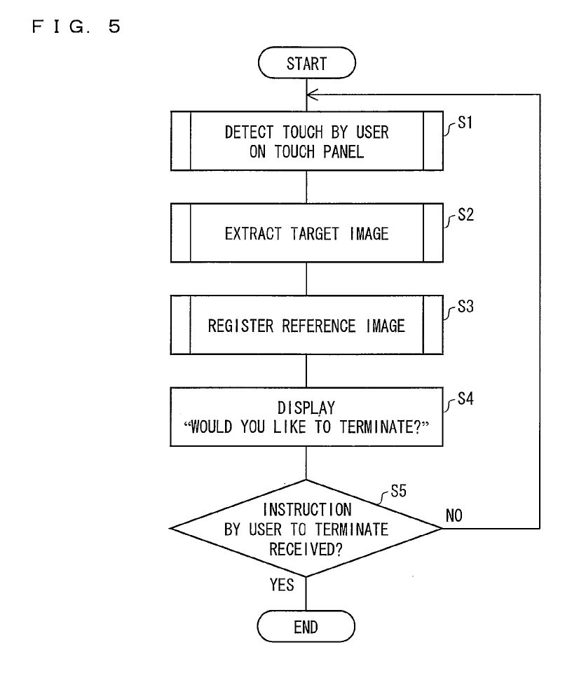

Referring to FIG. 1 and FIGS. 5 to 8, the following describes steps performed in the input detection device 1 according to the embodiment of the present invention, starting from a step of detecting a touch by the user on the touch panel 3 to a step of registering the reference image in the input detection device 1. FIG. 5 is a flow chart showing a processing flow that the input detection device 1 according to the embodiment of the present invention registers the reference image.

As illustrated in FIG. 5, first, the input detection device 1 detects a touch by the user on the touch panel 3 (step S1). Then, the input detection device 1 detects a target image (step S2). Subsequently, the input detection device 1 registers a reference image (step S3). The details of these steps will be described later. After S3, the input detection device 1 displays a message “Would you like to terminate?” on the touch panel 3, and waits for an instruction by the user (step S4). Upon receipt of an instruction by the user to terminate (step S5), the input detection device 1 terminates the process. The user's instruction to terminate is given by, for example, pressing down an OK button by the user. In the absence of an instruction to terminate in S5, the process goes back to S1, and the input detection device 1 detects a touch by the user on the touch panel 3 again.

The input detection device 1 thus repeats the operations from S1 to S5 until the user completes the registration of all the reference images. This allows a plurality of images to be registered as a plurality of reference images in a case where the user does not wish a plurality of fingers to be sensed by the input detection device 1 as fingers of input targets, for example.

In this way, the reference images can be prepared in advance in the input detection device 1. This makes it possible to determine, based on the reference images prepared in advance, whether or not the inputs by the user are invalid inputs.

(Detection of User's Touch)

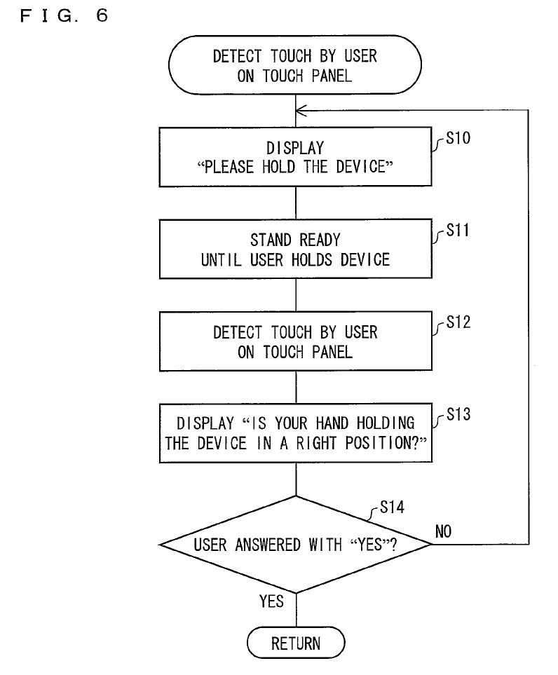

Referring now to FIG. 6, the following describes a process of detecting a touch by the user on the touch panel 3. FIG. 6 is a flow chart showing a processing flow that the input detection device 1 according to the embodiment of the present invention detects a touch by the user on the touch panel 3.

As shown in FIG. 6, first, the input detection device 1 displays on the touch panel 3 a message: “Please hold the device” (step S10). In response to this instruction, the user adjusts a position of his/her hand holding the input detection device 1 so that the hand is at a position convenient for manipulating the touch panel 3. The input detection device 1 stands ready until the user touches the touch panel 3 (step S11). When the input detection device 1 detects a touch by the user on the touch panel 3 (step S12), the input detection device 1 displays on the touch panel 3 a message “Is your hand holding the device in a right position?” (step S13) to confirm that the user comfortably holds the input detection device 1. If the user answers to this question with “Yes” by pressing down the OK button, for example (step S14), the process of detecting how the user holds the input detection device 1 is terminated. If the user answers in S14 with “No”, the process is not terminated and goes back to S10.

As described above, the input detection device 1 repeatedly confirms whether the user comfortably holds the device until the user answers with “Yes”. This allows the user to adjust the hand holding the device so as to be in a comfortable state for manipulating until the user is satisfied with the position of the hand.

The above description was made on the supposition that part of the user's hand touches the touch panel 3. However, a touch by the user is not limited to that with the part of the user's hand. For example, the user may touch the touch panel 3 with an arbitrary object that the user does not wish to be sensed by the input detection device 1 as an input target. For example, the user may touch the touch panel 3 with any finger other than the finger with which the user manipulates the device, a plurality of fingers, some other object, or the like. This raises the possibility of sensing information of a human fingertip, especially a fingerprint and the like.

(Detection of Target Image)

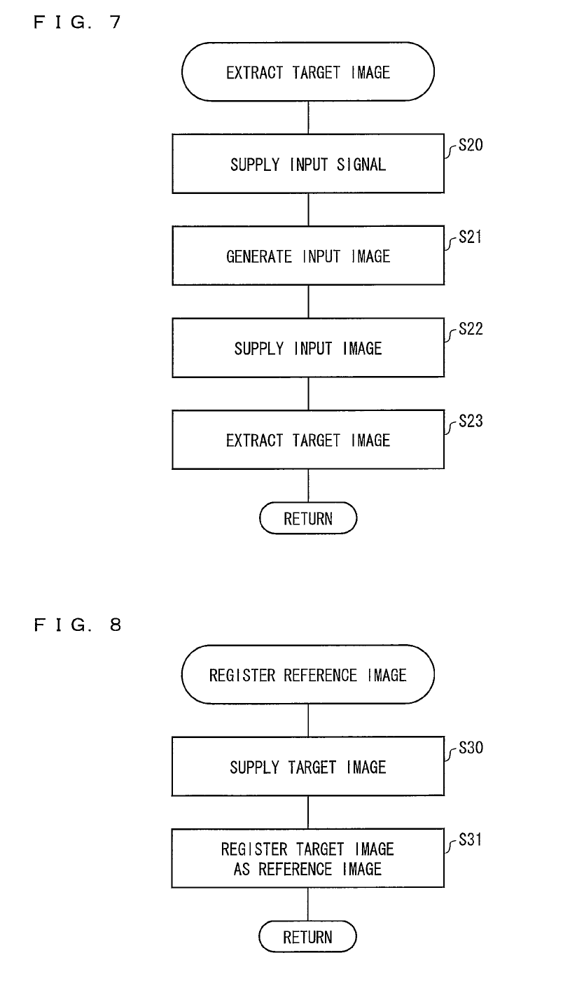

With reference to FIGS. 1 and 7, the following describes a process of extracting an input by the user to the touch panel 3 as an image. FIG. 7 is a flow chart showing a flow of extracting the input by the user to the touch panel 3 as a target image. In the present embodiment, the extracted image is termed an “input image”.

The readout drivers 21 of the display unit 2 supply the input section 5 with information of a touch by the user on the touch panel 3 as an input signal (step S20). The input section 5 generates an input image from the input signal (step S21), and supplies the input image to the input image identification section 6 (step S22). The input image identification section 6 extracts, from the received input image, only the image of the spot touched by the user on the touch panel 3, and terminates the process (step S23). Here, the “image of the spot touched by the user” means an image of a fingertip of the user that touches the touch panel 3.

(Registration in Memory)

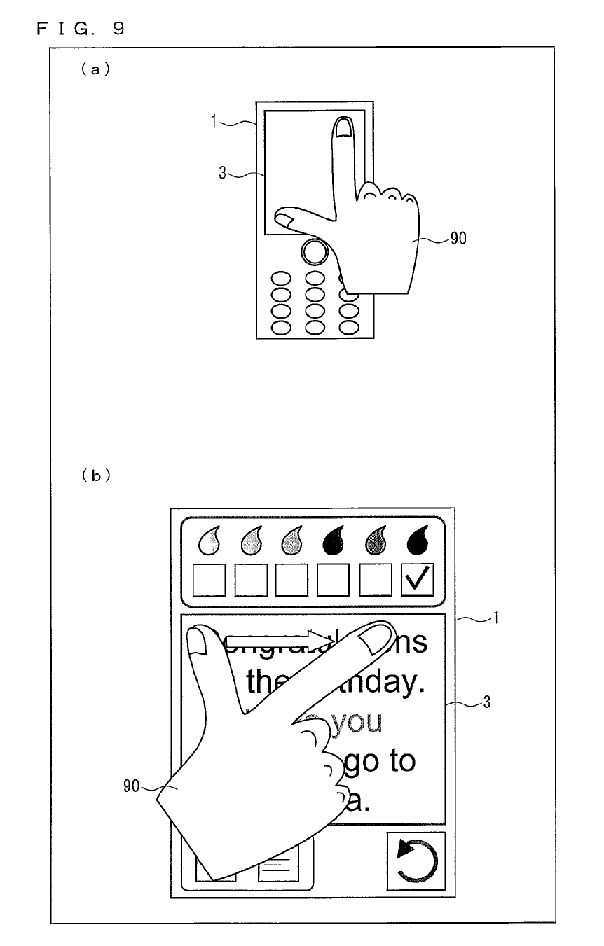

FIG. 8 is a flow chart showing a flow of registering the target image extracted in S23 as a reference image. The following describes the details of the processing flow.

The input image identification section 6 supplies the target image extracted in S23 to the reference image registration section 7 (step S30). The reference image registration section 7 registers the received target image as a reference image in the memory 8 (step S31) and terminates the process.

(Another Example of Use of Touch Panel 3)

Referring now to FIG. 9, the following describes an example of use of the touch panel 3 which example is different from the example illustrated in FIG. 3.

(a) of FIG. 9 is a drawing illustrating a manipulation of the touch panel 3 by the user with a plurality of fingers of his/her hand 90.

(b) of FIG. 9 is an enlarged view of (a) of FIG. 9 and Illustrates a manipulation of the touch panel 3 by the user. (b) of FIG. 9 depicts that a thumb and a forefinger of the hand 90 touching and moving on the touch panel 3 allows the characters displayed on the screen to be zoomed in and out and changed in color, the entire screen to be moved, and so on.

When the user manipulates the touch panel 3 with a plurality of fingers as illustrated in FIG. 9, registration of the images of the fingers as the reference images may sometimes cause the operation intended by the user not to be detected correctly. More specifically, the registered fingerprint information causes an input by a finger that is supposed to be detected as a normal input to be erroneously sensed as an invalid input.

(Matching Target Region)

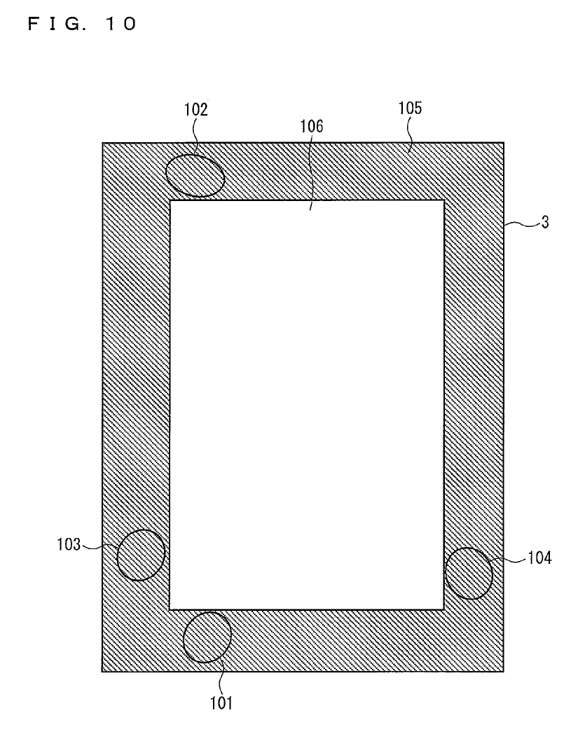

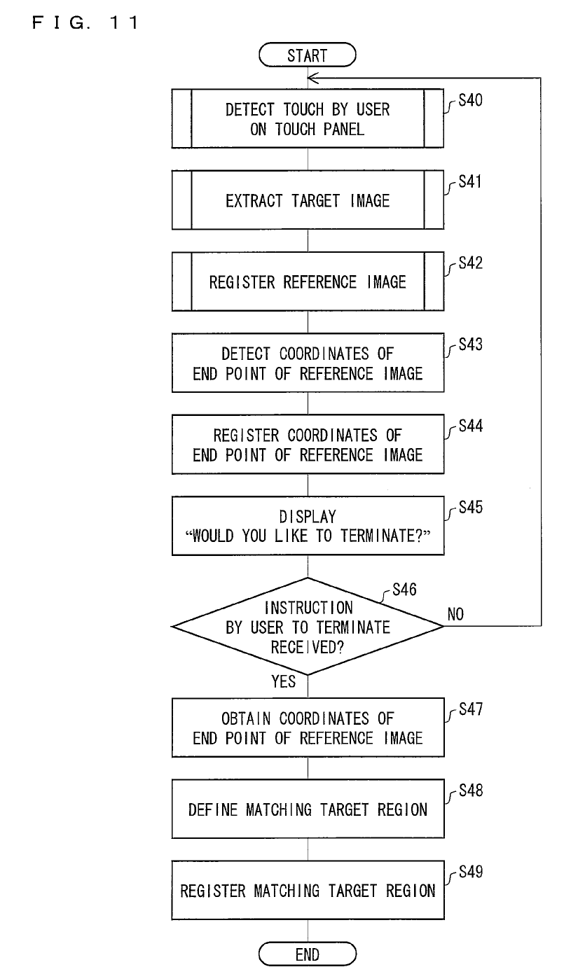

In order to avoid such an improper sensing, the input detection device 1 according to the embodiment of the present invention defines an area of coordinates in which area the input image is checked against the reference image and the input image is extracted as the target image. The following describes the area with reference to FIG. 10. In the present embodiment, the process of this checking is hereinafter termed “matching”. FIG. 10 illustrates a region where the matching between the input image and the reference image is to be performed and a region where the matching between the input image and the reference image is not to be performed.

As illustrated in FIG. 10, the touch panel 3 includes a shaded region 105 and a region 106 positioned on an inner side of the region 105. The region 105 is a matching target region in which the matching between the input image and the reference image is to be performed. On the other hand, the region 106 is a matching nontarget region in which the matching is not to be performed. The target region 105 is defined based on the coordinate information of each of the reference images 101 to 104.

Referring to FIGS. 1 and 11 to 13, the following describes steps of defining the target region 105 in detail.

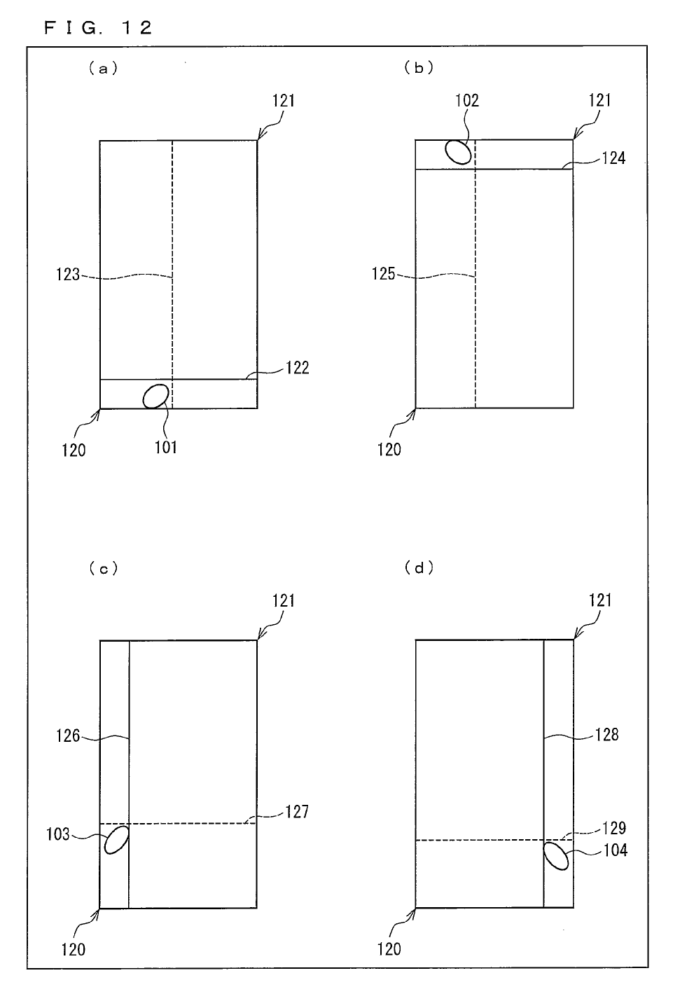

FIG. 11 is a flow chart showing a flow of registration of the region in which the matching between the input image and the reference image is to be performed.

As shown in FIG. 11, the input detection device 1 detects a touch by the user on the touch panel (step S40), extracts the target image (step S41), and registers the reference image (step S42). The details of these steps have already been described in the above.

A matching target region definition section 9 of the input detection device 1 detects coordinates of an end point of the reference image (step S43), and registers the coordinates in the memory 8 (step S44). After S44, the input detection device 1 displays on the touch panel 3 a message “Would you like to terminate?” and waits for an instruction of the user (step S45). Upon receipt of an instruction to terminate by the user (step S45), the matching target region definition section 9 obtains the coordinates of the end point of the reference image from the memory 8 (step S47). Then, based on the obtained coordinates of the end point of the reference image, a matching target region is defined (step S48) and registered in the memory 8 (step S49), and the process is terminated. In the absence of an instruction to terminate by the user in S46, the process goes back to S40. The details of each step will be described later.

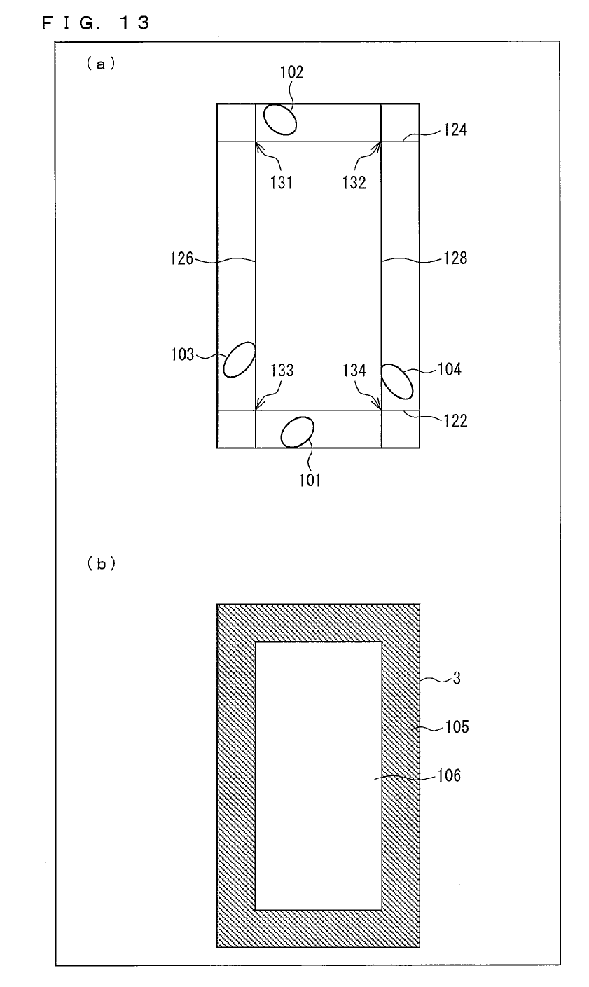

With reference to FIG. 12, the processes in S43 and S44 are now described in detail.

(End Point of Reference Image)

FIG. 12 is a drawing showing steps of detecting the coordinate of the end point of the reference image and registering the coordinate.

In FIG. 12, the screen has a size of 240×320 pixels. In this screen, coordinates 120 serve as base point coordinates. That is, at the coordinates 120 on the bottom left corner of the screen, both an X-coordinate and a Y-coordinate have a value of zero. In other words, the coordinates 120 are represented by (X, Y)=(0, 0). Meanwhile, the coordinates 121 on the upper right corner of the screen is represented by (X, Y)=(240, 320).

(a) to (d) of FIG. 12 illustrate how the coordinates of the end points of the reference images 101 to 104 are detected, respectively. Here, the “coordinate of the end point of the reference image” means, when detecting an X-coordinate and a Y-coordinate of an end point of a reference image which end point is located on the screen center side, one of the X-coordinate and the Y-coordinate which is located on a more screen end side.

With reference to (a) of FIG. 12, first is described how the coordinate of the end point of the reference image 101 is detected. The matching target region definition section 9 obtains the reference image 101 from the memory 8. Then, the X-coordinate of the end point of the reference image 101 on the screen center side is detected. Here, assume that a dashed line 123 is a line represented by X=130. Subsequently, the Y-coordinate of the end point of the reference image 101 on the screen center side is detected. Here, assume that a line 122 is a line represented by Y=30. In this step, a coordinate located on a more screen end part side is detected. Therefore, as a result of a comparison between X=130 and Y=30, the matching target region definition section 9 detects Y=30 as the coordinate of the end point of the reference image 101, and registers it in the memory 8.

Similarly to the above, with reference to (b) of FIG. 12, the following describes how the coordinate of the end point of the reference image 102 is detected. The matching target region definition section 9 obtains the reference image 102 from the memory 8. Then, the X-coordinate of the end point of the reference image 102 on the screen center side is detected. Here, assume that a dashed line 125 is a line represented by X=60. Subsequently, the Y-coordinate of the end point of the reference image 102 on the screen center side is detected. Here, assume that a line 124 is a line represented by Y=280. In this step, a coordinate located on a more screen end part side is detected. Therefore, as a result of a comparison between X=60 and Y=280, the matching target region definition section 9 detects Y=280 as the coordinate of the end point of the reference image 102, and registers it in the memory 8.

Similarly to the above, with reference to (c) of FIG. 12, described below is how the coordinate of the end point of the reference image 103 is detected. The matching target region definition section 9 obtains the reference image 103 from the memory 8. Then, the X-coordinate of the end point of the reference image 103 on the screen center side is detected. Here, assume that a line 126 is a line represented by X=40. Subsequently, the Y-coordinate of the end point of the reference image 103 on the screen center side is detected. Here, assume that a dashed line 127 is a line represented by Y=90. In this step, a coordinate located on a more screen end part side is detected. Therefore, as a result of a comparison between X=40 and Y=90, the matching target region definition section 9 detects X=40 as the coordinate of the end point of the reference image 103, and registers it in the memory 8.

Similarly to the above, with reference to (d) of FIG. 12, next is described how the coordinate of the end point of the reference image 104 is detected. The matching target region definition section 9 obtains the reference image 104 from the memory 8. Then, the X-coordinate of the end point of the reference image 104 on the screen center side is detected. Here, assume that a line 128 is a line represented by X=200. Subsequently, the Y-coordinate of the end point of the reference image 104 on the screen center side is detected. Here, assume that a dashed line 129 is a line represented by Y=80. In this step, a coordinate located on a more screen edge side is detected. Therefore, as a result of a comparison between X=200 and Y=80, the matching target region definition section 9 detects X=200 as the coordinate of the end point of the reference image 104, and registers it in the memory 8.

So far, the coordinates of the end points of the reference images 101 to 104 are respectively detected and registered in the memory 8.

(Definition of Matching Target Region)

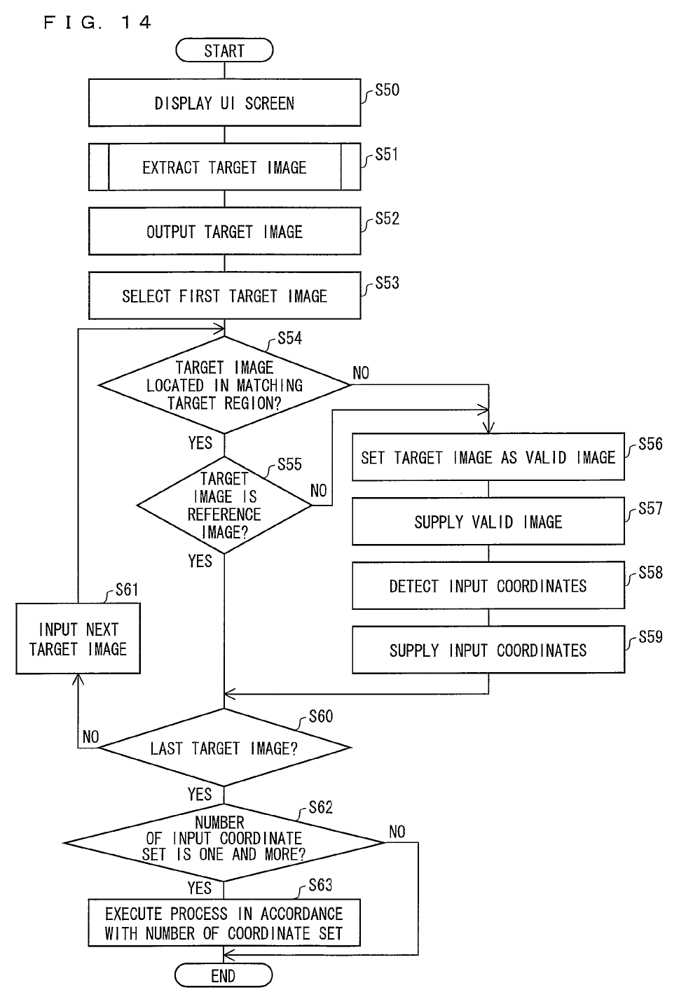

Referring now to FIG. 13, the following describes the details of the processes carried out in S47 and the subsequent steps in FIG. 11. FIG. 13 is a drawing illustrating a region in which the matching between the input image and the reference image is performed. The region is defined based on the coordinates of the reference images.

(a) of FIG. 13 shows the reference images 101 to 104, the lines 122, 124, 126, and 128 represented by the coordinates of the end points of the respective reference images, and coordinates 131 to 134. First, the matching target region definition section 9 obtains all the coordinates of the end points of the reference images 101 to 104 registered in the memory 8. The lines represented by the coordinates of the end points of the reference images are, as detected in the aforementioned steps, represented as follows: The line 122 is represented by Y=30, the line 124 is represented by Y=280, the line 126 is represented by X=40, and the line 128 is represented by X=200. Note that these lines based on the coordinates of the end points of the respective reference images are illustrated for ease of understanding the detection of the coordinates described in the following. The matching target region definition section 9 does not actually draw the lines on the screen.

The matching target region definition section 9 then finds coordinates 131 to 134 which are coordinates of intersections of the lines 122, 124, 126, and 128. The coordinates 131 are the coordinates of the intersection of the lines 124 and 126, that is, (X, Y)=(40, 280). The coordinates 132 are the coordinates of the intersection of the lines 124 and 128, that is, (X, Y)=(200, 280). The coordinates 133 are the coordinates of the intersection of the lines 122 and 126, that is, (X, Y)=(40, 30). The coordinates 134 are the coordinates of the intersection of the lines 122 and 128, that is, (X, Y)=(200, 30).

The matching target region definition section 9 defines, as the matching target region 105, the entire region of the coordinates located on the screen end part side with respect to the four coordinates that are found as above. (b) of FIG. 13 illustrates the matching target region 105 thus defined. Defining the region on the screen end part side as the matching target region 105 makes it possible to register a region in which the object used for the input is likely to touch the touch panel.

The matching target region definition section 9 stores the matching target region 105 in the memory 8. This allows the input detection device 1 to more correctly find and register in advance the display region that an object to be sensed as an reference image is likely to touch.

In the display region on the screen displayed by the touch panel 3, the region other than the matching target region 105 is a matching nontarget region 106. The matching nontarget region 106 is a region that is not registered in the memory 8 as the matching target region 105. As such, the input detection device 1 senses the matching nontarget region 106 as a region in which no matching is to be performed.

(Use of Touch Panel 3 after Registration of Reference Image)

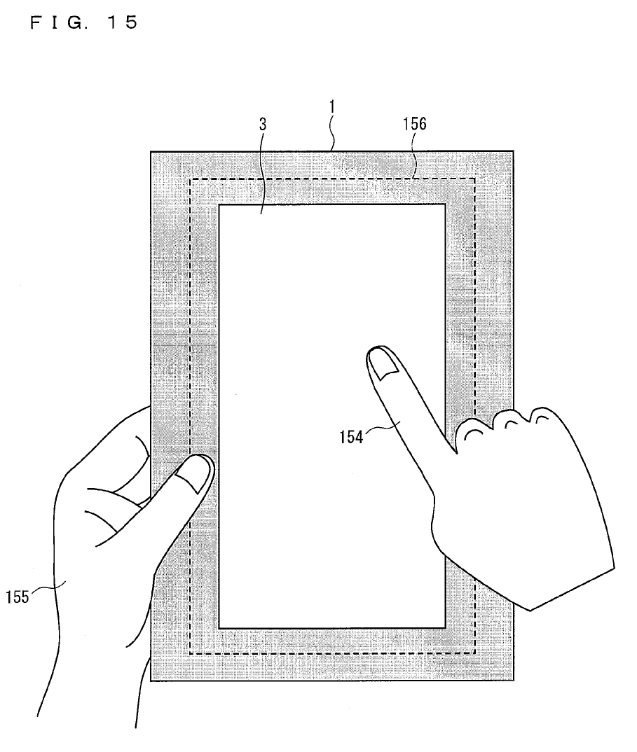

Referring to FIGS. 1 and 14, the following describes a process performed in the input detection device 1 when the user uses the touch panel 3 with the reference image registered in advance as described above. FIG. 14 is a flow chart showing a flow of the processes performed in the input detection device 1 according to the embodiment of the present invention when the touch panel 3 is in use.

As illustrated in FIG. 14, the input detection device 1 displays a UI screen (step S50). The input detection device 1 then extracts a target image from the input image (step S51). The details of the step of extracting the target image have already been described in the above.

(Valid Image)

The input image identification section 6 supplies the target image to a valid image selection section 10 (step S52). The valid image selection section 10 selects a first target image (step S53).

The valid image selection section 10 obtains the matching target region from the memory 8, and determines whether or not the target image is located within the matching target region (step S54).

In a case where the target image is determined to be located within the matching target region in S 54, the valid image selection section 10 obtains the reference images from the memory 8, and determines whether or not the target image matches any one of the obtained reference images (step S55).

If the target image matches none of the obtained reference images in S55, the target image is set as a valid image (step S56).

In a case where the target image is determined not to be located within the matching target region in S54, the process proceeds to S56 without going through S55.

After S56, the valid image selection section 10 supplies the valid image to the input coordinate detection section 11 (step S57). The input coordinate detection section 11 detects a center coordinate of the supplied valid image as an input coordinate (step S58), and supplies the input coordinate to the application control section 12 (step S59).

Following S59, the input detection device 1 determines whether the target image is the last target image (step S60).

If the target image matches any one of the obtained reference images in S55, the target image is sensed as a reference image. Then, the process proceeds to S60 without going through S56 to S59.

In a case where the target image is determined to be the last target image in S60, the input detection device 1 determines whether or not the number of the input coordinates supplied to an application control section 12 are one and more sets (step S62).

Meanwhile, in a case where the target image is determined not to be the last target image in S60, the input image identification section 6 supplies the next target image to the valid image selection section 10 (step S61), and the process goes back to S54.

(Application Control)

In a case of “Yes” in S62, necessary processes are performed in accordance with the number of the input coordinate set(s) (step S63), and the process is terminated. In a case of “No” in S62, on the other hand, the process is terminated without further steps.

As described above, the input detection device 1 can correctly obtain the input coordinate intended by the user. An effect is thus produced that erroneous manipulation of the touch panel 3 is avoided.

(Additional Effects)

In addition to the above-mentioned effect, with reference to FIG. 15, the following describes effects produced by the input detection device 1 according to the present invention. FIG. 15 is a drawing presented to explain the additional effects of the input detection device according to the embodiment of the present invention.

In a case where information of a fingertip of a hand 155 holding the input detection device is registered as a reference image, the input detection device 1 detects only the image of the fingertip of the hand holding the input detection device as an invalid input. As such, a finger 154 can freely manipulate the input detection device 1 by pressing down arbitrary spots on the touch panel 3 except the part where the hand 155 holding the input detection device touches the touch panel 3.

Specifically, any touches on the touch panel 3 in the part where the hand 155 holding the input detection device touches are generally sensed as invalid inputs. The hand 155 holding the input detection device is likely to touch a plurality of spots on the touch panel 3. The input detection device 1 senses each touch by the hand 155 as a reference image. That is, the user can freely move the hand without worrying about whether the spot where the hand 155 holding the input detection device is touching is sensed. The user can thus concentrate on the manipulation with the finger 154.

A dashed line 156 shows that a frame part (hereinafter referred to as a “frame”) used by the user to hold and support the input detection device 1 can be narrowed to the size indicated by the dashed line 56. This is possible because a touch by the hand 155 on the touch panel 3 displaying the UI screen does not cause an improper operation, since the hand 155 holding the input detection device is registered as a reference image, as described above. Narrowing the frame allows the weight of the input detection device 1 to be reduced.

Note that the present invention is not limited to the foregoing embodiment. Those skilled in the art may vary the present invention in many ways without departing from the claims. That is, a new embodiment may be provided from a combination of technical means arbitrarily altered within the scope of claims.

(Program and Storage Medium)

Finally, the blocks included in the input detection device 1 may be realized by way of hardware or software as executed by a CPU (Central Processing Unit) as follows:

The input detection device 1 includes a CPU and memory devices (storage media). The CPU executes instructions in programs realizing the functions. The storage devices include a ROM (Read Only Memory) which contains programs, a RAM (Random Access Memory) to which the programs are loaded in an executable form, and a memory containing the programs and various data. With this configuration, the objective of the present invention can also be achieved by a predetermined storage medium.

The storage medium may record program code (executable program, intermediate code program, or source program) of the program for the input detection device 1 in a computer readable manner. The program is software realizing the aforementioned functions. The storage medium is provided to the input detection device 1. The input detection device 1 (or CPU, MPU) that serves as a computer may retrieve and execute the program code contained in the provided storage medium.

The storage medium that provides the input detection device 1 with the program code is not limited to the storage medium of a specific configuration or kind. The storage medium may be, for example, a tape, such as a magnetic tape or a cassette tape; a magnetic disk, such as a Floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The objective of the present invention can also be achieved by arranging the input detection device 1 to be connectable to a communications network. In that case, the aforementioned program code is delivered to the input detection device 1 over the communications network. The communication network may be able to deliver the program codes to the input detection device 1, and is not limited to the communications network of a particular kind or form. The communications network may be, for example, the Internet, an intranet, extranet, LAN, ISDN, VAN, CATV communications network, virtual dedicated network (virtual private network), telephone line network, mobile communications network, or satellite communications network.

The transfer medium which makes up the communications network may be an arbitrary medium that can transfer the program code, and is not limited to a transfer medium of a particular configuration or kind. The transfer medium may be, for example, wired line, such as IEEE 1394, USB (Universal Serial Bus), electric power line, cable TV line, telephone line, or ADSL (Asymmetric Digital Subscriber Line); or wireless, such as infrared radiation (IrDA, remote control), Bluetooth (Registered Trademark), 802.11 wireless, HDR, mobile telephone network, satellite line, or terrestrial digital network. The present invention can also be realized in the mode of a computer data signal embedded in a carrier wave in which data signal the program code is embodied electronically.

As described above, only in a case where an image whose coordinate needs to be detected is sensed, the present input detection device detects the coordinate of the image. This makes it possible to correctly obtain the input coordinate intended by the user. As such, an effect is produced that an erroneous manipulation of the touch panel can be avoided.

The specific embodiments or examples described in the detailed description of the invention are solely intended to disclose the techniques of the present invention and should not be narrowly interpreted as limiting to such specific examples. The embodiments and examples may be varied in many ways without departing from the spirit of the present invention.

### INDUSTRIAL APPLICABILITY

The present invention can widely be used as an input detection device (especially as a device with a scanning function) with a multi-point detection touch panel. For example, the present invention can be realized as an input detection device that is mounted to operate on a portable device such as a mobile telephone, a smart phone, a PDA (Personal Digital Assistant), or an electronic book.

1. An input detection device having a multi-point detection touch panel, comprising:
image generation means generating an image of an object sensed by the touch panel;
determination means determining whether or not the image matches a predetermined reference image prepared in advance; and
coordinate finding means finding, if the image is determined not to match the reference image by the determination means, coordinates of the image on the touch panel.

2. The input detection device according to claim 1, further comprising:
registering means registering the image as a new reference image.

3. The input detection device according to claim 1, wherein
the determination means determines whether or not the image of the object sensed by the touch panel in a predetermined region in the touch panel matches the reference image.

4. The input detection device according to claim 1, further comprising:
registering means registering the image as a new reference image; and
region definition means defining the predetermined region based on the registered new reference image.

5. The input detection device according to claim 4, wherein
the region definition means defines, as the predetermined region, a region surrounded by one of a plurality of edges of the touch panel nearest to the new reference image and a line parallel to the edge and tangent to the new reference image.

6. The input detection device according to claim 3, wherein
the predetermined region is in a vicinity of an end part of the touch panel.

7. The input detection device according to claim 1, wherein
the reference image is an image of a finger of a user.

8. A method of detecting an input, the method being executed by an input detection device having a multi-point detection touch panel, comprising the steps of:
generating an image of an object sensed by the touch panel;
determining whether or not the image matches a predetermined reference image prepared in advance; and
finding, if the image is determined not to match the reference image by the determination means, coordinates of the image on the touch panel.

9. A program for operating an input detection device according to claim 1,
the program causing a computer to function as each of the means.

10. (canceled)
